(19) United States
(12) Patent Application Publication
(10) Pub. No.: US 2026/0077688 A1
(43) Pub. Date: Mar. 19, 2026

(54) VEHICLE SEAT

(71) Applicant: Adient US LLC, Plymouth, MI (US)

(72) Inventors: Stefan HABER, Pirmasens (DE); Joachim KÄMMERER, Kaiserslautern (DE); Ralph RECKTENWALD, Freisen (DE); Peter MÜLLER, Mackenbach (DE)

(21) Appl. No.: 19/332,155

(22) Filed: Sep. 18, 2025

(30) Foreign Application Priority Data
Sep. 19, 2024 (DE) 10 2024 209 007.7

(51) Int. Cl. B60N 2/12

(52) U.S. Cl. CPC B60N 2/12

(57) ABSTRACT

A vehicle seat may have a seat part, a backrest, a kinematics system for transferring the vehicle seat from a use position to an entry position and back, a locking mechanism, having two pawls for releasably locking at least part of the vehicle seat, an actuating mechanism for unlocking the two pawls, and a single position indicator which, as a common sensor, detects a locking position of the two pawls.

### FIELD

The invention relates to a vehicle seat, in particular an adjustable vehicle seat.

### BACKGROUND

The prior art discloses vehicle seats with different kinematics systems for adjusting seat parts, such as, for example, different backrest adjusters with fittings for manual or electrically operated adjustment of a seat back of a vehicle seat with or without easy-entry systems which enable different comfort or use positions of the seat back or an entry position of the vehicle seat for easier entry into a second seat row of a vehicle. For this purpose, locking mechanisms are known which are usually releasably lockable in order, upon unlocking, to move, in particular to pivot, the backrest or the entire seat from a comfort position or use position to an entry position. If the vehicle seat is arranged on rails, the vehicle seat can additionally be displaceable out of the entry region in the direction of travel when the locking mechanism is actuated.

### SUMMARY

The problem addressed by the invention is to improve a vehicle seat of the type mentioned in the introduction, in particular to provide such a vehicle seat which is transferable both in an electromotively driven manner from a use position to an entry position and, for providing an emergency exit, manually from the use position to the entry position and is securely locked.

This problem is solved according to the invention by a vehicle seat having the features of claim 1.

Advantageous configurations, which may be used individually or in combination with one another, are the subject matter of the dependent claims.

The vehicle seat according to the invention comprises at least a seat part, a backrest, a kinematics system for transferring the vehicle seat from a use position to an entry position and back, a locking mechanism, having two pawls for the releasable locking of at least part of the vehicle seat, and an actuating mechanism for unlocking the two pawls, and also a single position indicator, in particular a microswitch, which, as a common sensor, detects a locking position of the two pawls.

The fact that the single position indicator is designed as a common sensor for detecting a locking position of two pawls of the locking mechanism means that fewer components are required and the costs are reduced. In addition, the single position indicator as common sensor is configured both for monitoring the locking position of the two pawls in the event of manual emergency unlocking and for monitoring the locking position in the event of normal unlocking, regardless of whether this is electromotively driven or is carried out manually.

The respective pawl is designed in particular as a blocking pawl, for example a bracing pawl, which engages lockingly in a counter-element, in particular in a bolt or bracket. In this case, the pawl may be designed, for example, as a bracing pawl, wherein the pawl and the counter-element are lockable with each other outside a self-locking region. The bracing pawl preferably has a bracing curve (curved bearing surface) for interaction with the counter-element, in particular the bolt or the bracket. The gradient of the bracing curve is chosen so that there is no self-locking between the bracing curve and the counter-element, but, under normal operation of the vehicle seat, an opening torque acting on the bracing pawl by this normal operation is less than a closing torque which is opposed to this opening torque and which is produced in particular by a preloaded spring which applies a spring force to the bracing pawl in the closing direction.

In mechanics, self-locking describes a resistance, caused by friction, against slipping or rotation of two bearing surfaces, which bear against each other, of two bodies. As soon as static friction is exceeded, the bearing surfaces are no longer in self-locking action and move with respect to each other. Self-locking is influenced in particular by an angle of inclination between the bearing surfaces, the surface roughness of the bearing surfaces and the material pairing.

For example, the actuating mechanism can be configured to unlock the two pawls synchronously. In particular, the actuating mechanism comprises a first pulling means and a second pulling means. For example, the first pulling means can be coupled on the one hand to a first pawl and on the other hand to an actuating mechanism for actuating the first pulling means for unlocking the first pawl and a second pawl. The second pulling means can be coupled, for example, as a coupling means on the one hand to the first pawl and on the other hand to the second pawl to transfer the actuation on the first pawl by means of the first pulling means via the second pulling means to the second pawl.

In one possible example, the first pulling means and the second pulling means are each formed as a Bowden cable. For example, the respective Bowden cable can comprise a rounded head which is held on the associated pawl in an operatively connected manner.

In particular, the two pawls can be arranged in a rear region of the vehicle seat and configured, in the locked state, each on a counter-element on a base, to be in releasable engagement with this counter-element and to hold the vehicle seat locked with respect to the base.

For example, the single position indicator can comprise a switching surface which bears against a counter-surface, in particular a control surface or cam surface, of one of the two pawls when this pawl is in the locked state. The single position indicator is designed in particular as a microswitch.

The base can be, for example, a longitudinal adjustment device of the vehicle seat, a supporting structure of the vehicle seat or a floor structure of a vehicle.

In summary and in other words, an adjustable vehicle seat is provided by the invention, the locking state of which on a plurality of pawls can be reliably monitored by means of a single position indicator.

The fact that the kinematics system is designed for both a manual and an electromotively driven transfer of the vehicle seat to the entry position provides a possibility, in emergency situations or situations in which an energy supply of the drive device has failed or is de-energized, to transfer the vehicle seat to at least the entry position to allow easier access to or exit from an interior of a vehicle. In the entry position, parts of the vehicle seat, in particular the backrest and the seat part, are preferably pivoted forward to facilitate access to a rear seat row. In this case, the vehicle seat can also have a longitudinal adjuster having seat rails, which is unlockable to assume the entry position, so that the vehicle seat is additionally slidable forward.

The vehicle seat can be a vehicle seat within a multi-part bench seat. The vehicle seat can be an undivided bench seat. The seat part can at least be indirectly connectable to a vehicle structure. The vehicle seat can be connectable to at least one seat rail of a longitudinal adjuster. The longitudinal adjuster can have a seat rail and a floor rail which is displaceable relative to the seat rail, which rails are lockable to each other for the adjustment of a seat longitudinal position. The longitudinal adjuster can be an electromotively drivable longitudinal adjuster. The longitudinal adjuster can be unlockable for manual transfer of the vehicle seat to the entry position.

A drive device can have an electric motor. The drive device can have an electric motor and a gear mechanism. The drive device can have a geared motor. The drive device can have a spindle drive or drive a spindle drive. The drive device can have a gear mechanism with an output shaft, wherein in particular a pinion is connected to the output shaft.

### DESCRIPTION OF THE FIGURES

The invention is explained in more detail below with reference to advantageous exemplary embodiments shown in the figures. However, the invention is not limited to these exemplary embodiments. In the figures:

FIG. 1 shows, in a schematic illustration, a vehicle seat with a longitudinal adjustment device,

FIG. 2 shows a perspective view of a detail of the vehicle seat in the region of its seat part, wherein the vehicle seat is in a use position and is locked,

FIG. 3 shows a further perspective view with a different detail of the vehicle seat in the region of a first pawl,

FIG. 4 shows an enlarged perspective view of the first pawl,

FIG. 5 shows a further perspective view with a different detail of the vehicle seat in the region of a second pawl, and

FIG. 6 shows an enlarged perspective view of the second pawl.

Mutually corresponding parts are provided with the same reference signs throughout the figures.

### DETAILED DESCRIPTION

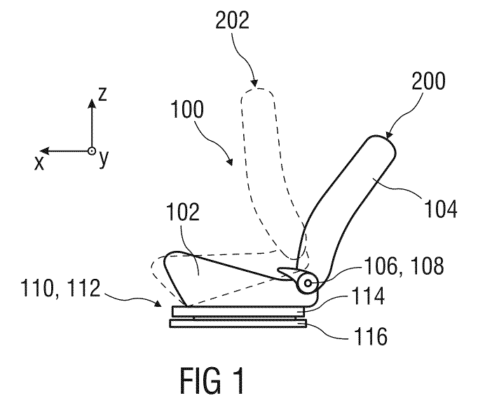

A vehicle seat 100 illustrated schematically in FIG. 1 in relation to the prior art will be described below using three spatial directions which extend perpendicularly to one another. In the case of a vehicle seat 100 installed in the vehicle, a longitudinal direction x extends substantially horizontally and preferably parallel to a vehicle longitudinal direction, which corresponds to the normal direction of travel of the vehicle. A transverse direction y which extends perpendicularly in relation to the longitudinal direction x is likewise oriented horizontally in the vehicle and extends parallel to a vehicle transverse direction. A vertical direction z extends perpendicularly in relation to the longitudinal direction x and perpendicularly in relation to the transverse direction y. In the case of a vehicle seat 100 installed in the vehicle, the vertical direction z preferably extends parallel to a vehicle vertical axis.

The positional and directional indications used, such as for example front, rear, top and bottom, relate to a viewing direction of an occupant seated on the vehicle seat 100 in a normal sitting position, the vehicle seat 100 being installed in the vehicle, in a use position suitable for passenger transport, with an upright backrest 104, and being oriented, as is customary, in the direction of travel. The vehicle seat 100 may, however, also be installed or moved in a different orientation, for example transversely to the direction of travel. Unless described otherwise, the vehicle seat 100 is constructed mirror-symmetrically with respect to a plane running perpendicularly in relation to the transverse direction y.

The backrest 104 can be arranged pivotably on a seat part 102 of the vehicle seat 100. For this purpose, the vehicle seat 100 may optionally comprise a fitting 106, in particular an adjustment fitting, rotary fitting, catching fitting or wobble fitting.

The positional and directional indications used, such as for example radial, axial and in the circumferential direction, refer to an axis of rotation 108 of the fitting 106. Radial means perpendicular to the axis of rotation 108. Axial means in the direction of or parallel to the axis of rotation 108.

The vehicle seat 100 may optionally comprise a longitudinal adjustment device 110. The longitudinal adjustment device 110 comprises, for example, a rail arrangement 112 having a first rail element 114 and a second rail element 116. The first rail element 114 is adjustable relative to the second rail element 116 in the longitudinal direction x. The first rail element 114 is fastened to the seat part 102. The second rail element 116 is fastened to a structural element of a vehicle, for example a vehicle floor.

For improved clarity, the first rail element 114 is referred to in the following description as upper rail 114. Said upper rail 114 (also referred to as running rail or carriage) is assigned to the vehicle seat 100 and is configured to support said vehicle seat 100. The second rail element 116 is referred to below as lower rail 116. The lower rail 116 is fixed and connected, for example, to the floor of a vehicle.

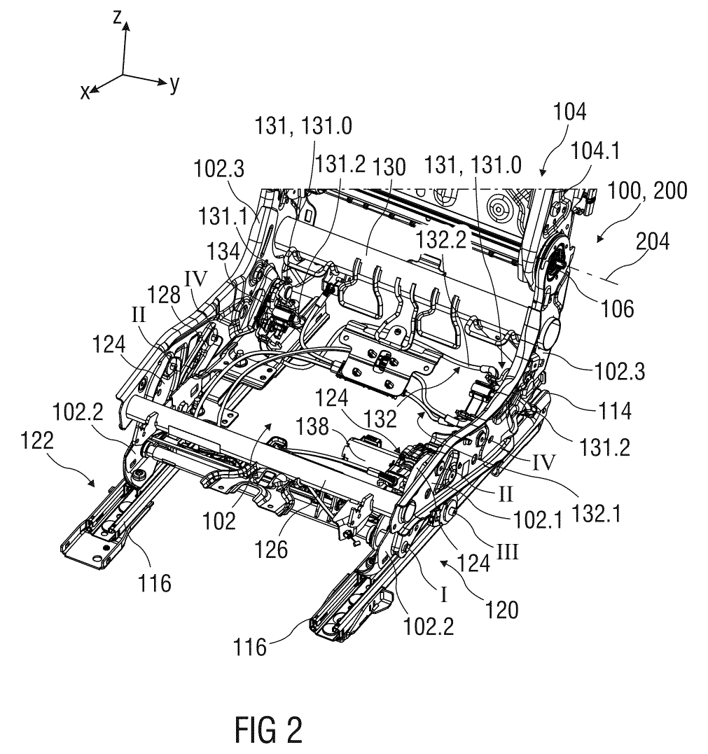

The vehicle seat 100 is in a use position 200 and is locked. The use position 200 serves to transport at least one seat occupant. The vehicle seat 100 is movable, in particular pivotable, from the use position 200 to an entry position 202 by means of a kinematics system 120 (shown in FIG. 2).

FIG. 2 shows a perspective view of a detail of the vehicle seat 100 in the region of its seat part 102. The vehicle seat 100 is in the use position 200 and is locked.

The vehicle seat 100, which is provided, for example, as an outer seat of a middle or rear seat row of a motor vehicle, for example a van, has the seat part 102 and the backrest 104. The backrest 104 is adjustable in its inclination about a backrest pivot axis 204 by means of at least one fitting 106, in the present case two fittings 106, so that a plurality of use positions 200 are defined. The term seat part 102 and backrest 104 should in each case be understood as meaning the entire assembly, having a seat part supporting structure 102.1 (as shown) and a covered cushion or a backrest supporting structure 104.1 and a covered cushion. In FIG. 2, only the seat part supporting structure 102.1 and the backrest supporting structure 104.1 are shown in each case without cushion and cover.

The entry position 202, for example, allows convenient access to a seat row (not shown) arranged behind the vehicle seat 100.

A base 122 of the vehicle seat 100 is connectable to a structure of the motor vehicle, in particular a vehicle floor (not shown). The base 122 is designed in the present case as a longitudinal adjustment device 110, which opens up the possibility of a longitudinal adjustment in and against the longitudinal direction x of the vehicle seat 100.

The base 122 has in the present case a floor rail, the lower rail 116, which is directly connectable to the vehicle structure, and a seat rail, the upper rail 114, which is displaceable relative thereto in the longitudinal direction x. The two profiled rails 114, 116 mutually engage behind one another with their inwardly or outwardly bent longitudinal edges. In the present case, the longitudinal adjustment device 110 is movable in a manner known per se by means of a spindle drive into any desired longitudinal adjustment position within a predetermined adjustment range.

The longitudinal adjustment device 110 can also be configured such that its rails 114, 116 are lockable with one another by means of a rail lock known per se, wherein the rail lock is manually unlockable by an occupant of the vehicle seat 100 by means of an unlocking bracket known per se.

A front foot 102.2 is mounted on the base 122, in the present case being firmly connected to the upper rail 114. Alternatively, the front foot 102.2 can also be releasably locked with the base 122, in particular with the upper rail 114.

In the region of a front end of the front foot 102.2, the seat part 102 is articulated by means of a swing arm 124, wherein this swing arm 124 has two ends and, in the region of these two ends, in each case a pivot joint I, II is provided, of which a first pivot joint I forms an articulation of the swing arm 124 on the front foot 102.2 and a second pivot joint II forms an articulation of the swing arm 124 on the front end of the seat part 102.

The swing arm 124 of the left vehicle seat side can be connected to the swing arm 124 of the right vehicle seat side via a cross tube 126.

The seat part 102 is articulated on the front foot 102.2 by means of a link 128 arranged behind the swing arm 124. The link 128 has two ends, wherein in the region of these two ends in each case a pivot joint III, IV is provided. A third pivot joint III forms an articulation of the link 128 on the front foot 102.2 and a fourth pivot joint IV forms an articulation of the link 128 on the seat part 102. On both sides of the vehicle seat 100, exactly one such link 128 is correspondingly arranged.

The front foot 102.2, the swing arm 124, the link 128 and the seat part 102 form the kinematics system 120, in the present case a four-joint assembly. The vehicle seat 100 is movable by means of the kinematics system 120 along a predetermined movement path from the use position 200 to the entry position 202 and back.

On the base 122 there is also arranged, behind the front foot 102.2 in the longitudinal direction x, a rear foot 102.3 which is formed separately from the front foot 102.2. The rear foot 102.3 of the left vehicle seat side is connected to the rear foot 102.3 of the right vehicle seat side via a cross connection 130.

The rear foot 102.3 is releasably locked with the base 122 by means of a locking mechanism 131 mounted on the rear foot 102.3.

The locking mechanism 131 comprises two locks 131.0 which are each formed on one of the vehicle seat sides. The respective lock 131.0 comprises a pawl 131.1, in particular a movable blocking pawl or bracing pawl, and an associated counter-element 131.2, in particular a lock bracket 131.2.

For example, the respective rear foot 102.3 with the associated counter-element 131.2 (also referred to as locking element fixed to the base), which in the present case is fastened to the lower rail 116, is indirectly connectable via the latter to the vehicle structure. The counter-element 131.2 is designed in particular as a positionally fixed lock bracket 131.2 and is referred to below as lock bracket 131.2 for better clarity.

In a locked state of the associated lock 131.0, the respective lock bracket 131.2 is centered in a slot-like cutout of the rear foot 102.3 or alternatively of a lock housing of the lock 131.0 and is in locked engagement with the pawl 131.1, for example in the form of a rotary latch, of the lock 131.0 and is thus prevented from leaving the cutout. The cutout (also referred to as an opening) can have a V-shaped contour and is open in the direction of the base 122. The cutout tapers conically in a direction oriented away from the base 122. In the use position 200 of the vehicle seat 100, the pawls 131.1 and the lock brackets 131.2 of the locks 131.0 fix the rear feet 102.3 of the vehicle seat 100 relative to the base 122 on this base 122.

In summary, the two pawls 131.1 are arranged in the rear region of the vehicle seat 100 and configured, in the locked state of the locks 131.0, in each case on the counter-element 131.2, the lock bracket 131.2, on the base 122, to be in releasable engagement with this lock bracket 131.2 and to hold the vehicle seat 100 locked with respect to the base 122.

The two pawls 131.1 are releasably held in locked engagement on the lock brackets 131.2. An actuating mechanism 132 is provided for unlocking. For monitoring the position or the state of the locks 131.0, a single position indicator 134 is provided which, as a common sensor, detects a locking position of the two pawls 131.1.

Owing to the fact that the single position indicator 134 is designed as a common sensor for detecting the locking position of the two pawls 131.1, fewer components are required. The single position indicator 134 as a common sensor is configured both for monitoring the locking position of the two pawls 131.1 in the event of manual emergency unlocking and for monitoring the locking position in the event of normal unlocking, regardless of whether this is electromotively driven or is carried out manually.

For example, the actuating mechanism 132 can be configured to unlock the two pawls 131.1 synchronously. In particular, the actuating mechanism 132 comprises a first pulling means 132.1 and a second pulling means 132.2. The actuating mechanism 132 can also be coupled to a drive device 138, for example a spindle drive.

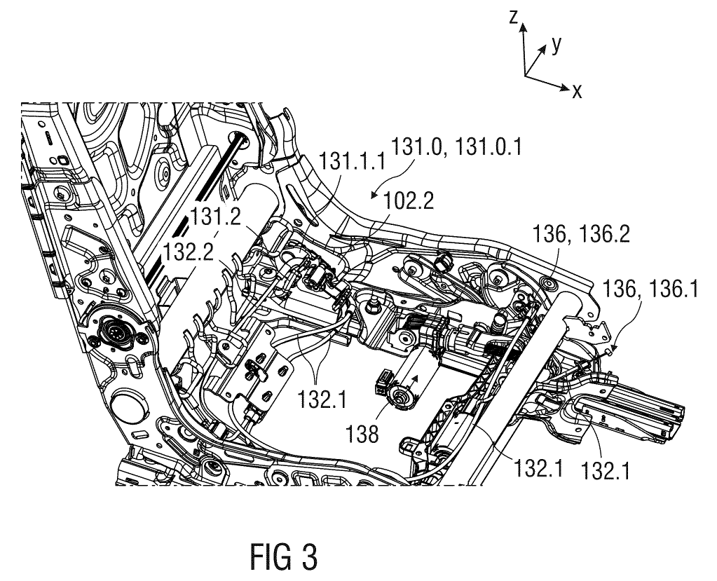

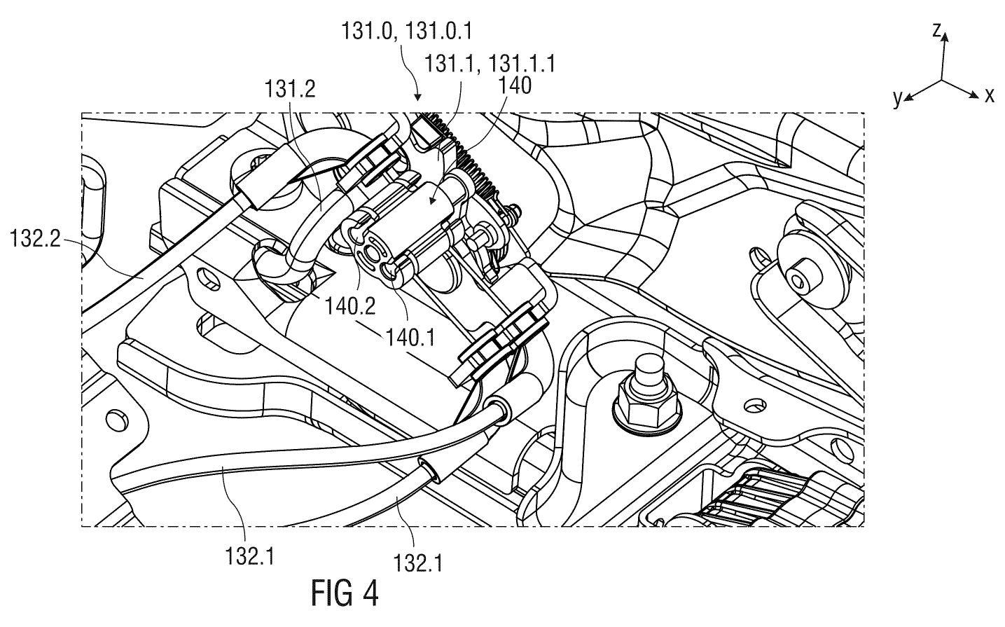

FIG. 3 shows a further perspective view with a different detail of the vehicle seat 100 in the region of a first pawl 131.1.1 of a first lock 131.0.1 of one of the locks 131.0 in the region of one of the rear feet 102.3. FIG. 4 shows an enlarged perspective view of the first pawl 131.1.1.

This first lock 131.0.1 is an, in particular inner, master lock (also referred to as a main lock) and is used for direct actuation by an actuating mechanism 136.

This first pawl 131.1.1 is directly unlockable by means of the first pulling means 132.1. The first pulling means 132.1 is coupled on the one hand to the first pawl 131.1.1 and on the other hand to the actuating mechanism 136 for direct, for example manual or electromotive, actuation of the first pulling means 132.1 for unlocking the first pawl 131.1.1. In the present case, the actuating mechanism 136 can be designed for two different actuating functions, in particular for emergency unlocking or for normal unlocking. An associated first pulling means 132.1 is provided for each actuating function.

The actuating mechanism 136 can comprise a first actuating interface 136.1 for manual emergency unlocking. The first actuating interface 136.1 is couplable to one end of one of the first pulling means 132.1.

The actuating mechanism 136 can comprise a second actuating interface 136.2 for electromotive or manual normal unlocking. The second actuating interface 136.2 is couplable or coupled to one end of one of the first pulling means 132.1 and is couplable or coupled to a drive device 138, for example a spindle drive.

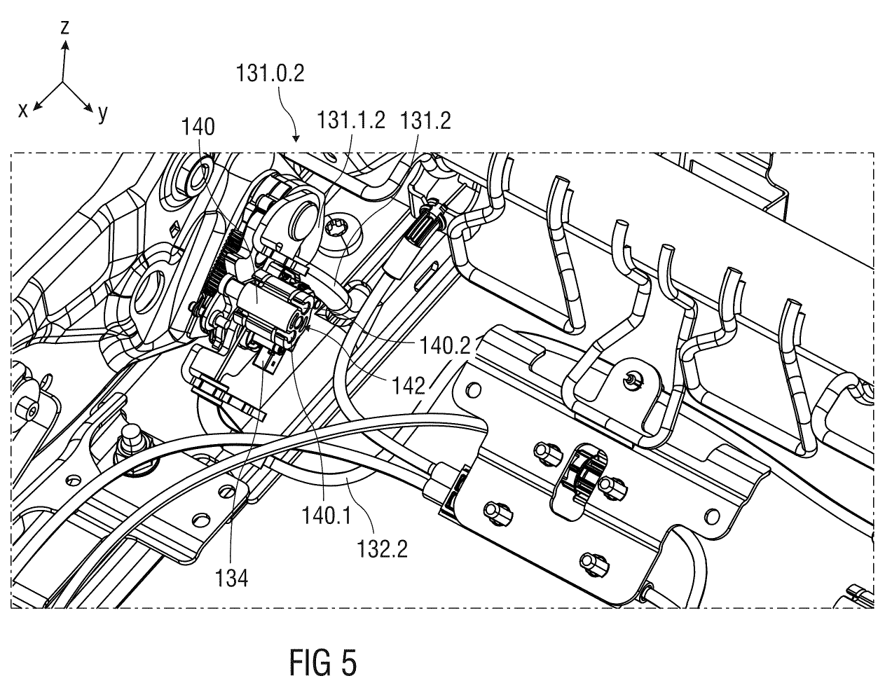

The second pulling means 132.2 can be coupled, for example, as a coupling means on the one hand to the first pawl 131.1.1 and on the other hand to a second pawl 131.1.2 (shown in FIG. 5) to transfer the actuation on the first pawl 131.1.1 by means of the first pulling means 132.1 via the second pulling means 132.2 to the second pawl 131.1.2.

In one possible example, the first pulling means 132.1 and the second pulling means 132.2 are each formed as a Bowden cable.

The respective Bowden cable can comprise, for example, a rounded head which is held in an operatively connected manner on the associated pawl 131.1, in particular the first pawl 131.1.1 or the second pawl 131.1.2.

FIG. 4 shows in detail the retention of the pulling means 132.1, 132.2 on the first pawl 131.1.1 as the master pawl of the first lock 131.0.1 (= main lock or master lock).

A pulling means interface 140 is mounted and held firmly on the first pawl 131.1.1. The pulling means interface 140 (also referred to as pulling means holder) comprises, on the one hand, a first receiving opening 140.1 (also referred to as holding opening) for the, or the first, pulling means 132.1 as direct actuating means for the first pawl 131.1.1 and, on the other hand, a second receiving opening 140.2 (also referred to as holding opening) for the second pulling means 132.2 as coupling means between the two pawls 131.1.

By coupling the two pawls 131.1 via the second pulling means 132.2, which is directly coupled in movement to the first pulling means 132.1 via the pulling means interface 140, both pawls 131.1 can be opened synchronously upon actuation of the first pulling means 132.1 by a user on one of the two actuating interfaces 136.1 or 136.2 (shown in FIG. 3) and thus the locks 131.0 can be unlocked.

FIG. 5 shows a further perspective view with a different detail of the vehicle seat 100 in the region of the second pawl 131.1.2 of a second lock 131.0.2, which, owing to the indirect actuation by the second pulling means 132.2, is also referred to as secondary lock or slave lock. The second lock 131.0.2 is located on the vehicle seat side which is opposite to the first lock 131.0.1 and which is, for example, more highly loaded by a belt connection, in particular a belt lock. As a result, the second lock 131.0.2 is also more highly loaded.

The second pulling means 132.2 is held on the second pawl 131.1.2, in particular held in a movement-coupled manner. Analogously to the first pawl 131.1.1, a pulling means interface 140 is mounted and held firmly on the second pawl 131.1.2. The two pulling means interfaces 140 can be of identical design. The respective pulling means interface 140 can be separately designed. Alternatively, the respective pulling means interface 140 can be an integrated component of the respective pawl 131.1.

The pulling means interface 140 (also referred to as pulling means holder) analogously comprises the two receiving openings 140.1, 140.2, of which, however, only one, for example the first receiving opening 140.1, is coupled to the second pulling means 132.2 as coupling means between the two pawls 131.1. The second receiving opening 140.2 remains free.

The second pawl 131.1.2 is engaged on the associated lock bracket 131.2.

The pulling means interface 140 can simultaneously comprise a counter-surface 142 for the single position indicator 134. Alternatively, the counter-surface 142 can be formed on the second pawl 131.1.2.

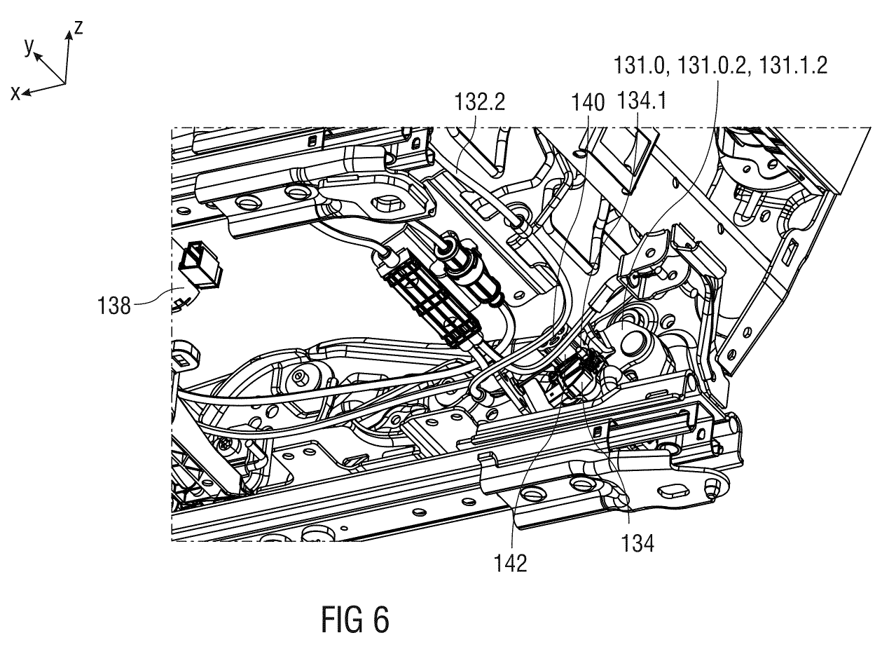

FIG. 6 shows an enlarged perspective view of the second pawl 131.1.2.

The single position indicator 134 comprises a switching surface 134.1 (also referred to as a switch or switching contour). The switching surface 134.1 bears on the counter-surface 142, in particular a control surface or cam surface, of the second pawl 131.1.2 when this second pawl 131.1.2 is in the locked state and thus detects the locked position of both locks 131.0. The single position indicator 134 is designed in particular as a microswitch.

In summary, a microswitch is mounted as the single position indicator 134 on the second lock 131.0.2 as a secondary lock, in particular an inner secondary lock. This microswitch can be used to check whether the highly loaded second lock 131.0.2 is closed. The purpose of this invention is that only a single microswitch is required as a single position indicator 134 to ensure that both locks 131.0 are closed, since both locks 131.0 are connected to the second pulling means 132.2 formed as a crossed Bowden cable (shown in FIG. 2).

This invention can be used for a manual vehicle seat 100 with manually actuatable locks 131.0 or for an electromotive vehicle seat 100 with locks 131.0 which are electromotively actuatable by means of the drive device 138 and/or are manually actuatable and/or mechanically unlockable by means of the pulling means 132.1, 132.2.

### LIST OF REFERENCE SIGNS

100 Vehicle seat

102 Seat part

102.1 Seat part supporting structure

102.2 Front foot

102.3 Rear foot

104 Backrest

104.1 Backrest supporting structure

106 Fitting

108 Axis of rotation

110 Longitudinal adjustment device

112 Rail arrangement

114 First rail element (upper rail, rail)

116 Second rail element (lower rail, rail)

120 Kinematics system

122 Base

124 Swing arm

126 Cross tube

128 Link

130 Cross connection

131 Locking mechanism

131.0 Lock

131.0.1 First lock

131.0.2 Second lock

131.1 Pawl

131.1.1 First pawl

131.1.2 Second pawl

131.2 Counter-element/lock bracket

132 Actuating mechanism

132.1 First pulling means

132.2 Second pulling means

134 Single position indicator

134.1 Switching surface

136 Actuating mechanism

136.1 First actuating interface

136.2 Second actuating interface

138 Drive device

140 Pulling means interface

140.1 First receiving opening

140.2 Second receiving opening

142 Counter-surface

200 Use position

202 Entry position

204 Backrest pivot axis

I First pivot joint, pivot joint

II Second pivot joint, pivot joint

III Third pivot joint, pivot joint

IV Fourth pivot joint, pivot joint

x Longitudinal direction

y Transverse direction

z Vertical direction

1. A vehicle seat, comprising:
a seat part, a backrest, a kinematics system for transferring the vehicle seat from a use position to an entry position and back, a locking mechanism, having two pawls, for releasably locking at least a part of the vehicle seat, an actuating mechanism for unlocking the two pawls, and a single position indicator which, as a common sensor, detects a locking position of the two pawls.

2. The vehicle seat as claimed inclaim 1, wherein the actuating mechanism is configured to unlock the two pawls synchronously.

3. The vehicle seat as claimed in claim 1, wherein the actuating mechanism comprises at least one first pulling means and at least one second pulling means.

4. The vehicle seat as claimed in claim 3, wherein the first pulling means is coupled on the one hand to a first pawl and on the other hand to the actuating mechanism for actuating the first pulling means for unlocking the first pawl.

5. The vehicle seat as claimed in claim 4, wherein the second pulling means as a coupling means is coupled on the one hand to the first pawl and on the other hand to a second pawl to transfer the actuation on the first pawl by means of the first pulling means via the second pulling means to the second pawl.

6. The vehicle seat as claimed in claim 3, wherein the first pulling means and the second pulling means are each formed as a Bowden cable.

7. The vehicle seat as claimed in claim 6, wherein the respective Bowden cable comprises a rounded head which is held on the associated pawl in an operatively connected manner.

8. The vehicle seat as claimed in claim 1, wherein the two pawls are arranged in a rear region of the vehicle seat and are configured, in the locked state, to each be in releasable engagement on a counter-element on a base and to hold the vehicle seat locked with respect to the base.

9. The vehicle seat as claimed in claim 7, wherein the single position indicator comprises a switching surface and this switching surface bears against a counter-surface of one of the two pawls when this pawl is in the locked state.

10. The vehicle seat as claimed in claim 7, wherein the base is a longitudinal adjustment device of the vehicle seat, a supporting structure of the vehicle seat or a floor structure of a vehicle.
